(19) United States
(12) Patent Application Publication
(10) Pub. No.: US 2024/0233220 A1
(43) Pub. Date: Jul. 11, 2024

(54) Foveated Anti-Aliasing

(71) Applicant: Apple Inc., Cupertino, CA (US)

(72) Inventors: Jad-Nicolas Khoury, San Francisco, CA (US); Thomas Post, San Mateo, CA (US)

(21) Appl. No.: 18/612,941

(22) Filed: Mar. 21, 2024

Related U.S. Application Data
(63) Continuation of application No. PCT/US22/43008, filed on Sep. 9, 2022.
(60) Provisional application No. 63/246,635, filed on Sep. 21, 2021.

(51) Int. Cl. G06T 11/40; G06T 3/40

(52) U.S. Cl. CPC G06T 11/40; G06T 3/40

(57) ABSTRACT

In one implementation, a method of generating an output image is performed by a device including a display, one or more processors, and non-transitory memory. The method includes obtaining a currently rendered image and an accumulation image based on previously rendered images. The method includes generating an output image based on the currently rendered image and the accumulation image, wherein the output image includes a first output pixel at a first output pixel location having a first output pixel value based on a first weighting of the currently rendered image and the accumulation image and the output image includes a second output pixel at a second output pixel location having a second output pixel value based on a second weighting of the currently rendered image and the accumulation image, wherein the second weighting is different than the first weighting. The method includes displaying, on the display, the output image.

### CROSS-REFERENCE TO RELATED APPLICATIONS

This application is a continuation of Intl. Patent App. No. PCT/US2022/043008, filed on Sep. 9, 2022, which claims priority to U.S. Provisional Patent App. No. 63/246,635, filed on Sep. 21, 2021, which are both hereby incorporated by reference in their entirety.

### TECHNICAL FIELD

The present disclosure generally relates to systems, methods, and devices for reducing aliasing in a foveated image stream.

### BACKGROUND

Foveated imaging is a digital image processing technique that takes advantage of the fact that humans typically have relatively weak peripheral vision. Accordingly, different portions of an image are rendered on a display panel with different resolutions. For example, in various implementations, portions corresponding to a user's field of focus are rendered with higher resolution than portions corresponding to a user's periphery. In various implementations, displaying a stream of foveated images, e.g., foveated video, causes flickering to occur in the periphery due to temporal aliasing. Whereas humans typically have relatively weak peripheral vision, such flickering is particularly noticeable and degrades the user experience.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIG. 4 illustrates a block diagram of a display pipeline in accordance with some implementations.

FIG. 5A illustrates an unfoveated image of XR content to be displayed in a display space.

FIG. 5B illustrates a warped image of the XR content of FIG. 5A.

FIG. 6 is a flowchart representation of a method of generating an output image based on a scaling factor map in accordance with some implementations.

FIG. 7 is a flowchart representation of a method of generating an output image based on two different weightings in two different regions.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating an output image based on two different weightings in two different regions. In various implementations, the method is performed by a device including a display, one or more processors, and non-transitory memory. The method includes obtaining a currently rendered image. The method includes obtaining an accumulation image based on previously rendered images. The method includes generating an output image based on the currently rendered image and the accumulation image, wherein the output image includes a first output pixel at a first output pixel location having a first output pixel value based on a first weighting of the currently rendered image and the accumulation image and the output image includes a second output pixel at a second output pixel location having a second output pixel value based on a second weighting of the currently rendered image and the accumulation image, wherein the second weighting is different than the first weighting. The method includes displaying, on the display, the output image.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As noted above, whereas humans typically have relatively weak peripheral vision, flickering in the periphery is particularly noticeable and degrades the user experience.

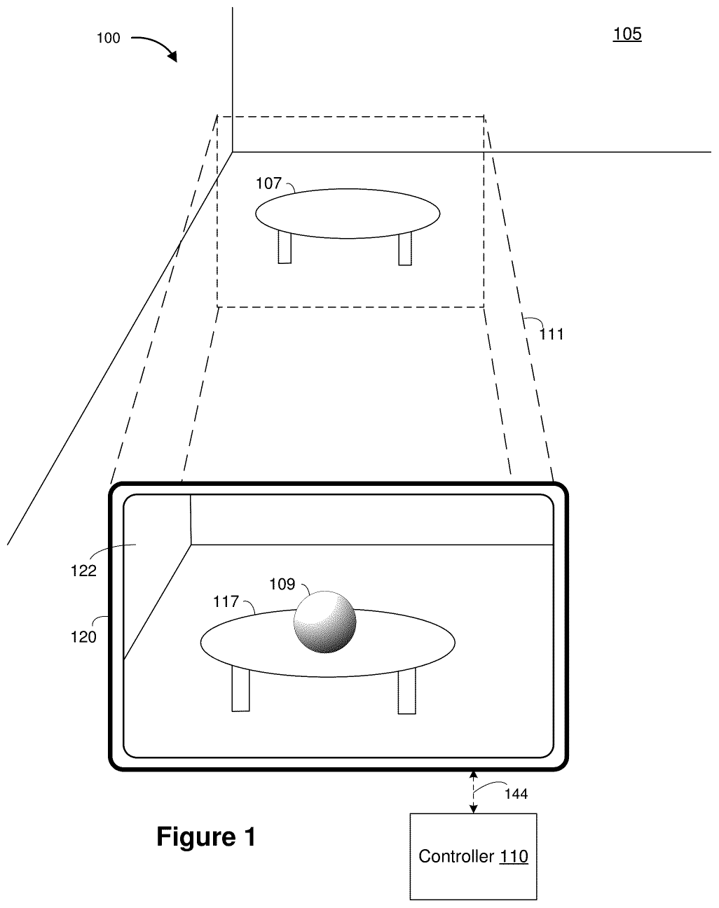

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

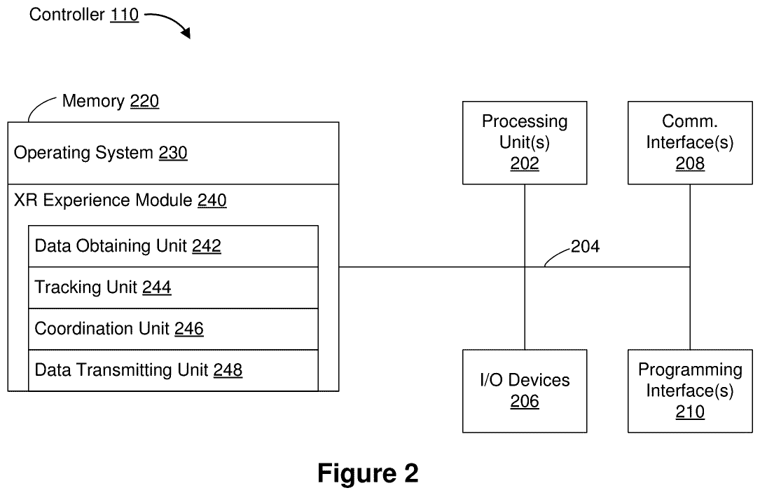

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

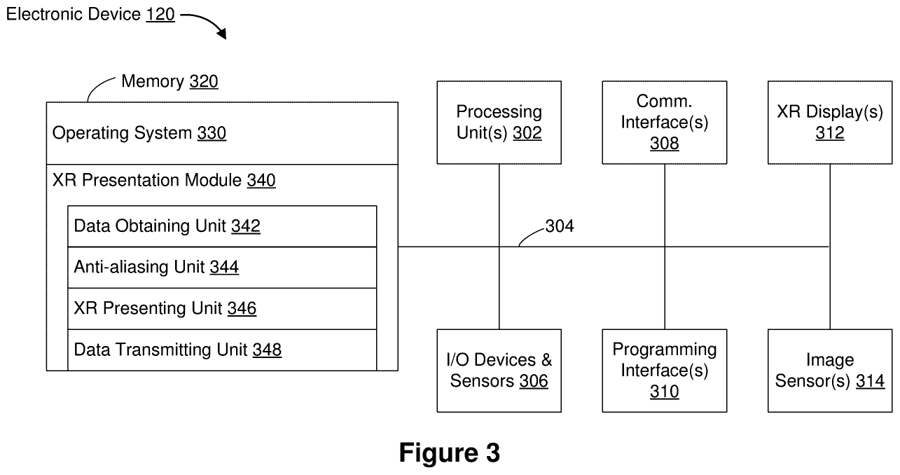

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR sphere 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, an anti-aliasing unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the anti-aliasing unit 344 is configured to generate an output image by blending a current rendered image with an accumulation image to reduce temporal aliasing. To that end, in various implementations, the anti-aliasing unit 344 includes instructions and/or logic therefor, and heuristics and metadata therefor.

In some implementations, the XR presenting unit 346 is configured to display the output image via the one or more XR displays 312. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the anti-aliasing unit 344, the XR presenting unit 346, and the data transmitting unit 348 are shown as residing on a single device (e.g., the electronic device 120), it should be understood that in other implementations, any combination of the data obtaining unit 342, the anti-aliasing unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

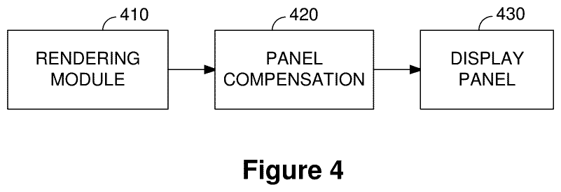

FIG. 4 illustrates a block diagram of a display pipeline 400 in accordance with some implementations. The display pipeline 400 includes a rendering module 410 which generates image data, a panel compensation module 420 which converts the image data into panel data, and a display panel 430 which displays an image by emitting light from each of a plurality of pixels as described by (e.g., according to) the panel data.

In various implementations, the display panel 430 includes a matrix of MxN pixels located at respective locations in a display space. In various implementations, in order to render an image for display on a display panel, the rendering module 410 generates M×N pixel values for each pixel of an M×N image. Thus, cach pixel of the rendered image corresponds to a pixel of the display panel with a corresponding location in the display space. Thus, the rendering module 410 generates a pixel value for M×N pixel locations uniformly spaced in a grid pattern in the display space.

Rendering M×N pixel values can be computationally expensive. In various implementations, in order to decrease the size of the rendered image without degrading the user experience, foveation (e.g., foveated imaging) is used. Foveation is a digital image processing technique in which the image resolution, or amount of detail, varies across an image. Thus, a foveated image has different resolutions at different parts of the image. Humans typically have relatively weak peripheral vision. According to one model, resolvable resolution for a user is maximum over the fovea (e.g., where the user is gazing) and falls off in an inverse linear fashion in the periphery. Accordingly, in one implementation, the image displayed by the display panel 430 is a foveated image having a maximum resolution in the fovea and a resolution in the periphery that decreases in an inverse linear fashion in proportion to the distance from the fovea.

Because some portions of the image have a lower resolution, an M×N foveated image includes less information than an M×N unfoveated image. Thus, in various implementations, the rendering module 410 generates, as a rendered image, a foveated image. The rendering module 410 can generate an M×N foveated image more quickly and with less processing power (and battery power) than the rendering module 410 can generate an M×N unfoveated image. Also, an M×N foveated image can be expressed with less data than an M×N unfoveated image. In other words, an M×N foveated image file is smaller in size than an M×N unfoveated image file. In various implementations, compressing an M×N foveated image using various compression techniques results in fewer bits than compressing an M×N unfoveated image.

A foveation ratio, R, can be defined as the amount of information in the M×N unfoveated image divided by the amount of information in the M×N foveated image. In various implementations, the foveation ratio is between 1.5 and 10. For example, in some implementations, the foveation ratio is 2. In some implementations, the foveation ratio is 3 or 4. In some implementations, the foveation ratio is constant among images. In some implementations, the foveation ratio is selected based on the image being rendered.

In some implementations, in order to render an image for display on the display panel 430, the rendering module 410 generates M/R×N/R pixel values for an M/R×N/R warped image. Each pixel of the warped image corresponds to an area greater than a pixel of the display panel 430 at a corresponding location in the display space. Thus, the rendering module 410 generates a pixel value for each of M/R×N/R locations in the display space that are not uniformly distributed in a grid pattern. The respective area in the display space corresponding to each pixel value is defined by a respective corresponding location in the display space (a rendering location) and a respective scaling factor indicating a size of the respective arca. In various implementations, each respective scaling factor is a scaling factor couple including a horizontal scaling factor indicating the width of the respective area in the display space and a vertical scaling factor indicating the height of the respective area in the display space. In various implementations, the respective scaling factors for each pixel can be represented as an M/R×N/R matrix referred to as a scaling factor map. As the scaling factor increases, the resolution at the rendering location decreases. In various implementations, the resolution at the rendering location is inversely proportional to the scaling factor. Accordingly, in various implementations, a resolution (or a resolution map) rather than a scaling factor (or scaling factor map) is used in various image processing algorithms described herein.

In various implementations, the rendering module 410 generates, as a rendered image, a warped image. In various implementations, the warped image includes a matrix of M/R×N/R pixel values for M/R×N/R locations uniformly spaced in a grid pattern in a warped space that is different than the display space. Particularly, the warped image includes a matrix of M/R×N/R pixel values for M/R×N/R locations in the display space that are not uniformly distributed in a grid pattern. Thus, whereas the resolution of the warped image is uniform in the warped space, the resolution varies in the display space.

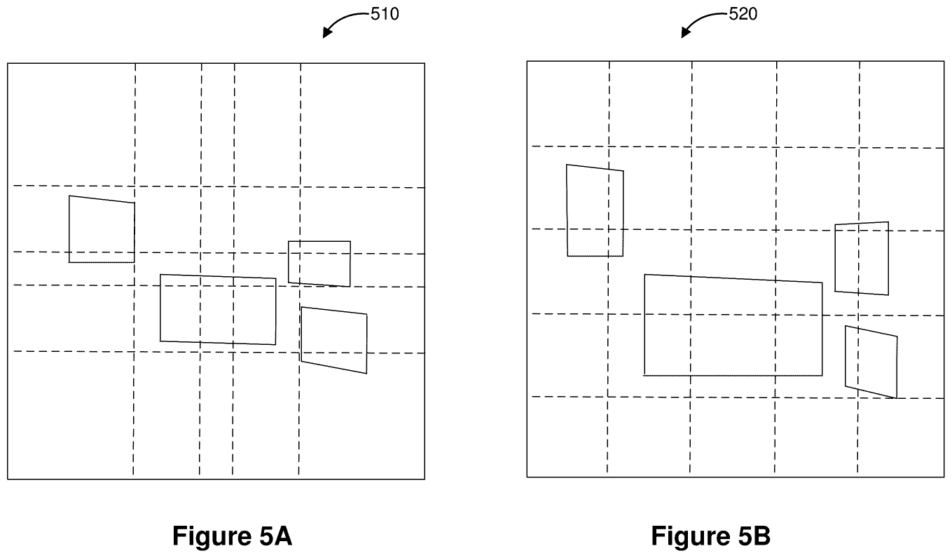

FIG. 5A illustrates an unfoveated image 510 of XR content to be displayed in a display space. FIG. 5B illustrates a warped image 520 of the XR content. Different parts of the XR content in the unfoveated image 510 corresponding to different amounts of area in the display space are rendered into the same amount of area in the warped image 520. For example, the area at the center of the unfoveated image 510 of FIG. 5A is represented by an area in the warped image 520 of FIG. 5B including K pixels (with K pixel values). Similarly, the area on the corner of the unfoveated image 510 of FIG. 5A (a larger area than the area at the center of FIG. 5A) is also represented by an area in the warped image 520 of FIG. 5B including K pixels (with K pixel values).

The panel compensation module 420 converts the image data into panel data. In various implementations, the panel compensation module 420 converts a warped image into a foveated image. For example, in various implementations, the panel compensation module 420 converts an M/R×N/R warped image into an M×N foveated image based on the scaling factor map. As noted above, the display panel 430 displays an image based on the panel data.

In various implementations, displaying a stream of foveated images, e.g., foveated video, causes flickering to occur in the periphery due to temporal aliasing. Whereas humans typically have relatively weak peripheral vision, such flickering is particularly noticeable and degrades the user experience. Accordingly, in various implementations, to reduce flickering, the rendering module 410 generates an output image that, at least in the periphery, is a weighted sum of (1) a current rendered image and (2) an accumulation image based on previously rendered images. Further, when the output image is a warped image, the weighting at each pixel is based on the respective scaling factor of the pixel.

In various implementations, at a rendering time, t, the rendering module 410 renders a rendered image, Rₜ, having a rendered image pixel at a location (xₜ,yₜ) in the image space with a rendered pixel value of R(xₜ,yₜ). Further, the rendering module 410 stores an accumulation image, Aₜ, having an accumulation image pixel at the location (xₜ,yₜ) with an accumulation image pixel value of Aₜ(xₜ,yₜ). Based on the rendered image and the accumulation image, the rendering module 410 generates an output image, Oₜ, having an output image pixel at the location (xₜ,yₜ) with an output image pixel value of Oₜ(xₜ,yₜ). In various implementations, the output image pixel value is a weighted sum of the rendered image pixel value and the accumulation image pixel value. Thus, Oₜ(xₜ,yₜ)=αRₜ(xₜ,yₜ)+(1−α)Aₜ(xₜ,yₜ), where α is a weighting factor, also referred to as an accumulation factor or blending factor.

Further, the rendering module 410 updates the accumulation image for the next rendering time, t+1, as the output image. Thus, Aₜ₊₁=Oₜ.

In various implementations, the perspective of the rendered image changes between rendering times. For example, in various implementations, a user of an electronic device displaying an XR environment moves the electronic device between rendering times. Failing to consider the change in perspective results, in various implementations, in a weighted sum of a rendered image from a first perspective with an accumulation image from a second perspective producing ghosting, smearing, or other undesirable artifacts.

In various implementations, the accumulation image lies in the same image space as the previous rendered image. We can therefore consider the accumulation image space and the previous rendered image space to be the same.

In various implementations, the projective transformation is a backward mapping in which, for each pixel of the current rendered image at a pixel location in a projected space, a new pixel location is determined in a unprojected space of the current rendered image. In various implementations, the projective transformation is a forward mapping in which, for each pixel of the current rendered image at a pixel location in an unprojected space, an accumulation pixel location is determined in the projected space of the accumulation image.

In various implementations, the pixel location in the accumulation image is determined according to the following equation in which xₜ and yₜ are the source pixel location at the current frame, xₜ₋₁ and yₜ₋₁ are the pixel location in reprojected space, Pₜ is a 4×4 view projection matrix representing the perspective of the current rendered image, Pₜ₋₁ is a 4×4 view projection matrix representing the perspective of previous rendered image (and the accumulation image), and d is the depth map for the current rendered image:

$$[ \begin{matrix}{x}_{t - 1} \\ {y}_{t - 1} \\ {z}_{t - 1} \\ {w}_{t - 1}\end{matrix} ] ← {P}_{t - 1} \cdot {P}_{t}^{- 1} \cdot [ \begin{matrix}{x}_{t} \\ {y}_{t} \\ d ( {x}_{t} , {y}_{t} ) \\ 1\end{matrix} ]$$

The above equation assumes, however, that the accumulation image and the current rendered image are foveated images or unfoveated images in which each pixel represents the same amount of area in a display space and not warped images in which different pixels represent different amounts of area in the display space. If the accumulation image and current rendered images are warped images, the source pixel location is determined according to the following equation in which x′ₜ and y′ₜ are the source pixel location in an unwarped version of the current rendered image space and x′ₜ₋₁ and y′ₜ₋₁ are the pixel location in an unwarped version of the accumulation image space:

$$[ \begin{matrix}{x}_{t - 1}^{′} \\ {y}_{t - 1}^{′} \\ {z}_{t - 1}^{′} \\ {w}_{t - 1}^{′}\end{matrix} ] ← {P}_{t - 1} \cdot {P}_{t}^{- 1} \cdot [ \begin{matrix}{x}_{t}^{′} \\ {y}_{t}^{′} \\ d ( {x}_{t} , {y}_{t} ) \\ 1\end{matrix} ]$$

A mapping, based on the scaling factor map of the current rendered image, Sₜ, exists from the pixel location in the warped current rendered image space (xₜ,yₜ) to the pixel location in the unwarped version of the current rendered image space (x′ₜ,y′ₜ). Thus, for some mapping M, (x′ₜ,y′ₜ)=M(xₜ,y_{y},Sₜ). Similarly, an inverse mapping, based on the scaling factor map of the accumulation image, Sₜ₋₁, exists from the pixel location in the unwarped version of the accumulation image space (x′ₜ₋₁,y′ₜ₋₁) to the pixel location in the warped version of the accumulation image space (xₜ₋₁,yₜ₋₁). Thus, (xₜ₋₁,yₜ₋₁)=M⁻¹(x′ₜ₋₁,y′ₜ₋₁,Sₜ₋₁).

In various implementations, the output image pixel value is a weighted sum of the rendered image pixel value and the accumulation image pixel value. Thus, Oₜ(xₜ,yₜ)=αRₜ(xₜ,yₜ)+(1−α)Aₜ(xₜ,yₜ).

However, as illustrated above, the pixel position in the reprojected accumulation image space (xₜ₋₁,yₜ₋₁) might be different from the source pixel position in the projected current rendered image (xₜ, yₜ) . . . Thus, the accumulation pixel value Aₜ(xₜ,yₜ)≠·Aₜ(xₜ₋₁,yₜ₋₁) . . . Accordingly, in various implementations, Oₜ(xₜ₋₁,yₜ₋₁)=αRₜ(x+,y+)+(1−α)Aₜ(xₜ₋₁,yₜ₋₁). In various implementations, the location (xₜ₋₁,yₜ₋₁) may be between existing pixels of the accumulation image, and the pixel value Aₜ(xₜ₋₁,yₜ₋₁) is determined using interpolation or other techniques.

In various implementations, before being added to the rendered image, the accumulation image is improved with filtering, color-correction, anti-ghosting or other processing. Accordingly, in various implementations, a function, F, is performed on the accumulation image, Aₜ, to generate a blending image, B. In various implementations, the output image pixel value is a weighted sum of the rendered image pixel value and the blending image pixel value. Thus, Oₜ(xₜ,yₜ)=αRₜ(xₜ,yₜ)+(1−α)B(xₜ₋₁,yₜ₋₁). Further, Oₜ(xₜ,yₜ)=αRₜ(xₜ,yₜ)+(1−α)F(Aₜ(xₜ₋₁,yₜ₋₁)). Thus, in various implementations, the output pixel value is a weighted sum of the rendered pixel value at a first location and function of the accumulation image pixel value at a second location corresponding to the first location via a projective transform.

If various implementations, the weighting factor, α, is a function of the scaling factor at the pixel location. Thus, Oₜ(xₜ, yₜ)=α(Sₜ(xₜ, yₜ)R+(xₜ, yₜ)+(1−α(S^{t}(xₜ,yₜ)))F(Aₜ(xₜ₋₁,yₜ₋₁)). In particular, in various implementations, the weighting factor, α, is a function of the horizontal scaling factor at the pixel location, S^{x}ₜ(xₜ,yₜ), and the vertical scaling factor at the pixel location, S^{y}ₜ(xₜ,yₜ).

In various implementations, the weighting factor, α, is proportional to the geometric mean of the inverse of the horizontal scaling factor at the pixel location, S^{x}ₜ(xₜ,yₜ), and the inverse of vertical scaling factor at the pixel location, S^{y}ₜ(xₜ,yₜ). Thus,

$$α = \frac{1}{n} {( \frac{1}{{S}_{t}^{x} \cdot {S}_{t}^{y}} )}^{1 / 2} ,$$

where n is normalization factor. In various implementations, the weighting factor, α, is proportional to a generalized geometric mean of the inverse of the horizontal scaling factor at the pixel location, S^{x}ₜ(xₜ,yₜ), and the inverse of the vertical scaling factor at the pixel location, S^{y}ₜ(xₜ,yₜ). Thus

$$s , α = \frac{1}{n} {( \frac{1}{{S}_{t}^{x} \cdot {S}_{t}^{y}} )}^{s} ,$$

where s is a scaling factor.

In various implementations, the weighting factor, α, is proportional to the root mean square of the inverse of the horizontal scaling factor at the pixel location, S^{x}ₜ(xₜ,yₜ), and the inverse of the vertical scaling factor at the pixel location, S^{y}ₜ(xₜ,yₜ). Thus, α=

$$\frac{1}{n} {( {( \frac{1}{{S}_{t}^{x}} )}^{2} + {( \frac{1}{{S}_{t}^{y}} )}^{2} )}^{1 / 2} .$$

In various implementations, the weighting factor, α, is higher in the fovea than in the periphery. In various implementations, the weighting factor, α, is 1 in the fovea, resulting in a bypass of the weighted averaging. In various implementations, a fovea threshold, τ, is defined as the largest scaling factor at which a pixel is considered to be in the fovea. In various implementations, the weighting factor, α, is 1 in the fovea, and proportional to a generalized geometric mean of the inverse of the horizontal scaling factor at the pixel location, S^{x}ₜ(xₜ,yₜ), and the inverse of the vertical scaling factor at the pixel location, S^{y}ₜ(xₜ,yₜ), outside of the fovea. Thus,

$$α = \{ \begin{matrix}1 & if \frac{1}{{S}_{t}^{x} \cdot {S}_{t}^{y}} \geq τ \\ \frac{1}{n} {( \frac{1}{τ} \cdot \frac{1}{{S}_{t}^{x} \cdot {S}_{t}^{y}} )}^{s} & if \frac{1}{{S}_{t}^{x} \cdot {S}_{t}^{y}} < τ\end{matrix} .$$

In various implementations, the weighting factor, α, is 1 in the fovea, and proportional to a root of the lesser of the inverse of the horizontal scaling factor at the pixel location, S^{x}ₜ(xₜ,yₜ), and the inverse of the vertical scaling factor at the pixel location, S^{y}ₜ(xₜ,yₜ), outside of the fovea. Thus,

$$α = \{ \begin{matrix}1 & if min ( \frac{1}{{S}_{t}^{x}} , \frac{1}{{S}_{t}^{y}} ) \geq τ \\ \frac{1}{n} {( \frac{1}{τ} \cdot min ( \frac{1}{{S}_{t}^{x}} , \frac{1}{{S}_{t}^{y}} ) )}^{s} & if min ( \frac{1}{{S}_{t}^{x}} , \frac{1}{{S}_{t}^{y}} ) < τ\end{matrix} .$$

In various implementations, the above formulas are simplified or linearized to avoid computation of division and power operations. Thus, in various implementations, where c is a scaling factor,

$$α = \{ \begin{matrix}1 & if \frac{1}{{S}_{t}^{x} \cdot {S}_{t}^{y}} \geq τ \\ \frac{1}{n} ( 1 - c ( 1 - \frac{1}{τ} \cdot \frac{1}{{S}_{t}^{x} \cdot {S}_{t}^{y}} ) ) & if \frac{1}{{S}_{t}^{x} \cdot {S}_{t}^{y}} < τ\end{matrix} .$$

Similarly, in various implementations,

$$α = \{ \begin{matrix}1 & if \frac{1}{{S}_{t}^{x} \cdot {S}_{t}^{y}} \geq τ \\ \frac{1}{n} ( 1 - c ( 1 - \frac{1}{τ} \cdot min ( \frac{1}{{S}_{t}^{x}} , \frac{1}{{S}_{t}^{y}} ) ) ) & if \frac{1}{{S}_{t}^{x} \cdot {S}_{t}^{y}} < τ\end{matrix} .$$

In various implementations, after computation using one of the above formulas, the weighting factor is clamped between a maximum value, αₘₐₓ, and a minimum value, αₘᵢₙ. Thus, in various implementations, where a pre-clamped weighting factor, αₚ, is determined using one of the above formulas, the weighting factor, α, is determined as α=min(max(αₘᵢₙ, ₚ), αₘₐₓ).

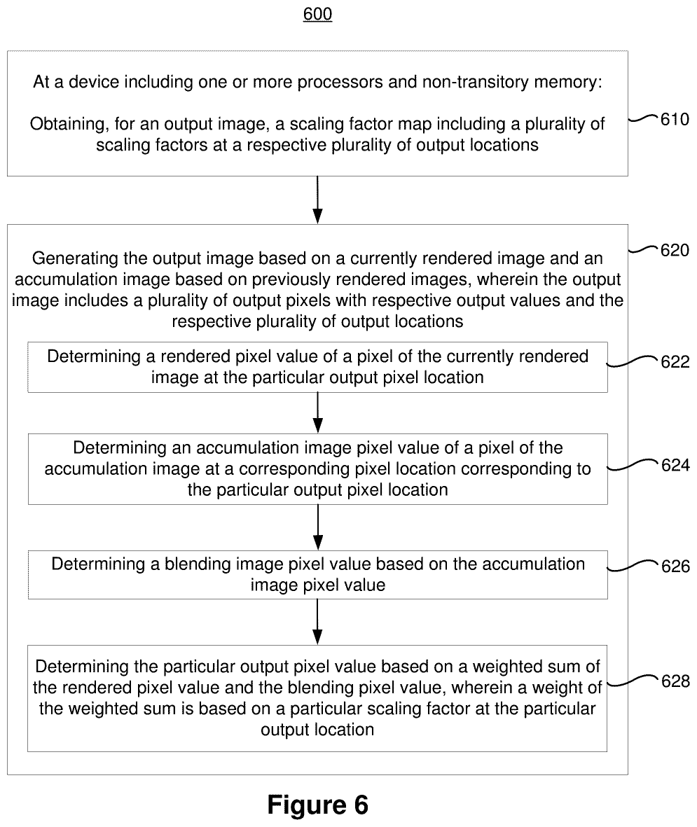

FIG. 6 is a flowchart representation of generating an output image based on a scaling factor map in accordance with some implementations. In various implementations, the method 600 is performed by a device with one or more processors and non-transitory memory (e.g., the electronic device 120 of FIG. 3). In some implementations, the method 600 is performed by processing logic, including hardware, firmware, software, or a combination thereof. In some implementations, the method 600 is performed by a processor executing instructions (e.g., code) stored in a non-transitory computer-readable medium (e.g., a memory).

The method 600 begins, in block 610, with the device obtaining, for an output image, a scaling factor map including a plurality of scaling factors at a respective plurality of output pixel locations. Each of the scaling factors indicates a size of an area of a display on which the output image, transformed into a foveated image, is displayed.

The method 600 continues, in block 620, with the device generating the output image based on a currently rendered image and an accumulation image based on previously rendered images, wherein the output image includes a plurality of output pixels with respective output pixel values at the respective plurality of output pixel locations. In various implementations, the currently rendered image is generated by a rendering module. In various implementations, the currently rendered image is a warped image. In various implementations, the currently rendered image is an image of an XR environment.

Generating the output image, in block 620, includes, for a particular output pixel having a particular output pixel value at a particular output pixel location, in block 622, determining a rendered pixel value of a pixel of the currently rendered image at the particular output pixel location.

Generating the output image, in block 620, includes, for a particular output pixel having a particular output pixel value at a particular output pixel location, in block 624, determining an accumulation image pixel value of a pixel of the accumulation image at a corresponding pixel location corresponding to the particular output pixel location. In various implementations, the corresponding pixel location is determined based on the particular output pixel location and a reprojection function. In various implementations, the reprojection function is based on the scaling factor map.

Generating the output image, in block 620, includes, for a particular output pixel having a particular output pixel value at a particular output pixel location, in block 626, determining a blending image pixel value based on the accumulation image pixel value. In various implementations, determining the blending image pixel value includes filtering a version of the accumulation image.

Generating the output image, in block 620, includes, for a particular output pixel having a particular output pixel value at a particular output pixel location, in block 628, determining the particular output pixel value based on a weighted sum of the rendered pixel value and the blending pixel value, wherein a weight of the weighted sum is based on a particular scaling factor at the particular output pixel location. In various implementations, the particular scaling factor includes a horizontal scaling factor and a vertical scaling factor and the weight is based on an inverse of the horizontal scaling factor multiplied by an inverse of the vertical scaling factor. In various implementations, the particular scaling factor includes a horizontal scaling factor and a vertical scaling factor and the weight is based on the lesser of an inverse of the horizontal scaling factor and an inverse of the vertical scaling factor.

In various implementations, generating the output image comprises, for a second particular output pixel having a second output pixel value at a second particular output pixel location, determining the second particular output pixel value as a second rendered pixel value of a pixel of the currently rendered image at the second particular output pixel location. In various implementations, the particular output pixel location is in a periphery and the second particular output pixel location is in a fovea. Accordingly, in various implementations, blending is bypassed in the fovea.

In various implementations, the method 600 includes storing the output image as an updated accumulation image. In various implementations, the method 600 includes generating a second output image based on a second currently rendered image and the updated accumulation image. In various implementations, generating the second output image includes, for a second particular output pixel, determining a second rendered pixel value of a pixel of the second currently rendered image at the particular output pixel location, determining a second accumulation image pixel value of a pixel of the updated accumulation image at a corresponding pixel location corresponding to the particular output pixel location, determining a second blending image pixel value based on the second accumulation image pixel value, and determining the second particular output pixel value based on a weighted sum of the second rendered pixel value and the second blending pixel value, wherein a weight of the weighted sum is based on a particular scaling factor at the particular output pixel location.

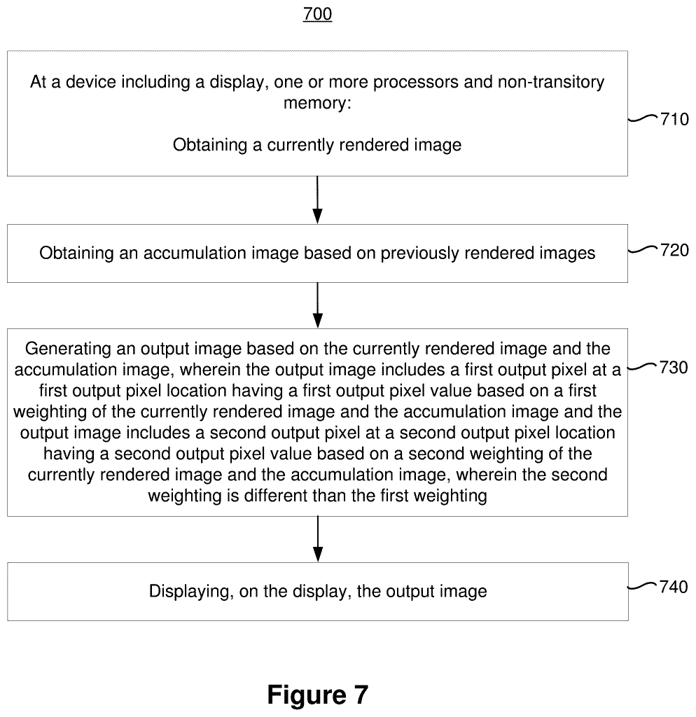

FIG. 7 is a flowchart representation of generating an output image based on two different weightings in two different regions in accordance with some implementations. In various implementations, the method 700 is performed by a device with a display, one or more processors, and non-transitory memory (e.g., the electronic device 120 of FIG. 3). In some implementations, the method 700 is performed by processing logic, including hardware, firmware, software, or a combination thereof. In some implementations, the method 700 is performed by a processor executing instructions (e.g., code) stored in a non-transitory computer-readable medium (e.g., a memory).

The method 700 begins, in block 710, with the device obtaining a currently rendered image. The method 700 continues, in block 720, with the device obtaining an accumulation image based on previously rendered images.

The method 700 continues, in block 730, with the device generating an output image based on the currently rendered image and the accumulation image. The output image includes a first output pixel at a first output pixel location having a first output pixel value and includes a second output pixel at a second output pixel location having a second output pixel value. In various implementations, the first output pixel location is in a periphery and the second output pixel location is in a fovea.

The first output pixel value is based on a first weighting of the currently rendered image and the accumulation image and the second output pixel value is based on a second weighting of the currently rendered image and the accumulation image, wherein the second weighting is different than the first weighting. In various implementations, the second weighting, e.g., in the fovea, includes weighting the currently rendered image to one and weighting the accumulation image to zero. Thus, in various implementations, the second output pixel value is a currently rendered image pixel value of a currently rendered image pixel at the second output pixel location of the currently rendered image.

In various implementations, the first weighting is based on a first scaling factor of the first output pixel location and the second weighting is based on a second scaling factor of the second output pixel location. In various implementations, the first scaling factor includes a horizontal scaling factor and a vertical scaling factor and the first weighting is based on an inverse of the horizontal scaling factor multiplied by an inverse of the vertical scaling factor. In various implementations, the first scaling factor includes a horizontal scaling factor and a vertical scaling factor and the first weighting is based on the lesser of an inverse of the horizontal scaling factor and an inverse of the vertical scaling factor.

In various implementations, the first output pixel value is a weighted sum of (1) a currently rendered image pixel value of a currently rendered image pixel at the first output pixel location of the currently rendered image and (2) a function of an accumulation image pixel value of an accumulation image pixel at a corresponding pixel location corresponding to the first output pixel location of the accumulation image. In various implementations, a weight of the weighted sum is based on a first scaling factor of the first output pixel location.

In various implementations, the corresponding pixel location is determined based on the first output pixel location and a reprojection function. In various implementations, the reprojection function is based on a scaling factor map including the first scaling factor of the first output pixel location. In various implementations, the function of the accumulation image is a filtering function or anti-ghosting function.

The method 700 continues, in block 740, with the device displaying, on the display, the output image. In various implementations, the method 700 further includes storing the output image as an updated accumulation image. In various implementations, the method 700 further includes generating a second output image based on a second currently rendered image and the updated accumulation image.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a display, one or more processors, and non-transitory memory;
obtaining a currently rendered image;
obtaining an accumulation image based on previously rendered images;
generating an output image based on the currently rendered image and the accumulation image, wherein the output image includes a first output pixel at a first output pixel location having a first output pixel value based on a first weighting of the currently rendered image and the accumulation image and the output image includes a second output pixel at a second output pixel location having a second output pixel value based on a second weighting of the currently rendered image and the accumulation image, wherein the second weighting is different than the first weighting; and
displaying, on the display, the output image.

2. The method of claim 1, wherein the first output pixel location is in a periphery and the second output pixel location is in a fovea.

3. The method of claim 1, wherein the second weighting includes weighting the currently rendered image to one and weighting the accumulation image to zero.

4. The method of claim 1, wherein the first weighting is based on a first scaling factor of the first output pixel location and the second weighting is based on a second scaling factor of the second output pixel location.

5. The method of claim 4, wherein the first scaling factor includes a horizontal scaling factor and a vertical scaling factor and the first weighting is based on an inverse of the horizontal scaling factor multiplied by an inverse of the vertical scaling factor.

6. The method of claim 4, wherein the first scaling factor includes a horizontal scaling factor and a vertical scaling factor and the first weighting is based on the lesser of an inverse of the horizontal scaling factor and an inverse of the vertical scaling factor.

7. The method of claim 1, wherein the first output pixel value is a weighted sum of a currently rendered image pixel value of a currently rendered image pixel at the first output pixel location of the currently rendered image and a function of an accumulation image pixel value of an accumulation image pixel at a corresponding pixel location corresponding to the first output pixel location of the accumulation image.

8. The method of claim 7, wherein a weight of the weighted sum is based on a first scaling factor of the first output pixel location.

9. The method of claim 7, wherein the corresponding pixel location is determined based on the first output pixel location and a reprojection function.

10. The method of claim 9, wherein the reprojection function is based on a scaling factor map including the first scaling factor of the first output pixel location.

11. The method of claim 7, wherein the function of the accumulation image is a filtering function or anti-ghosting function.

12. The method of claim 1, further comprising storing the output image as an updated accumulation image.

13. The method of claim 12, further comprising generating a second output image based on a second currently rendered image and the updated accumulation image.

14. A device comprising:
a display;
non-transitory memory; and
one or more processors to:
obtain a currently rendered image;
obtain an accumulation image based on previously rendered images;
generate an output image based on the currently rendered image and the accumulation image, wherein the output image includes a first output pixel at a first output pixel location having a first output pixel value based on a first weighting of the currently rendered image and the accumulation image and the output image includes a second output pixel at a second output pixel location having a second output pixel value based on a second weighting of the currently rendered image and the accumulation image, wherein the second weighting is different than the first weighting; and
display, on the display, the output image.

15. The device of claim 14, wherein the first output pixel location is in a periphery and the second output pixel location is in a fovea.

16. The device of claim 14, wherein the second weighting includes weighting the currently rendered image to one and weighting the accumulation image to zero.

17. The device of claim 14, wherein the first weighting is based on a first scaling factor of the first output pixel location and the second weighting is based on a second scaling factor of the second output pixel location.

18. The device of claim 1, wherein the first output pixel value is a weighted sum of a currently rendered image pixel value of a currently rendered image pixel at the first output pixel location of the currently rendered image and a function of an accumulation image pixel value of an accumulation image pixel at a corresponding pixel location corresponding to the first output pixel location of the accumulation image.

19. The device of claim 18, wherein the corresponding pixel location is determined based on the first output pixel location and a reprojection function.

20. A non-transitory memory storing one or more programs, which, when executed by one or more processors of a device having a display, cause the device to:
obtain a currently rendered image;
obtain an accumulation image based on previously rendered images;
generate an output image based on the currently rendered image and the accumulation image, wherein the output image includes a first output pixel at a first output pixel location having a first output pixel value based on a first weighting of the currently rendered image and the accumulation image and the output image includes a second output pixel at a second output pixel location having a second output pixel value based on a second weighting of the currently rendered image and the accumulation image, wherein the second weighting is different than the first weighting; and
display, on the display, the output image.
